(19) United States
(12) Patent Application Publication
(10) Pub. No.: US 2007/0064528 A1
(43) Pub. Date: Mar. 22, 2007

(54) Marine seismic streamer and method for manufacture thereof

(76) Inventors: D. Richard Metzbower, Austin, TX (US); Andre Stenzel, Richmond, TX (US)

Correspondence Address: E. Eugene Thigpen;Petroleum Geo-Services, Inc., P.O. Box 42805, Houston, TX, 77242-2805, US

(21) Appl. No.: 11/346,100

(22) Filed: Feb. 2, 2006

Related U.S. Application Data
(60) Provisional application No. 60/716,279, filed on Sep. 12, 2005.

(51) Int. Cl. G01V 1/38

(52) U.S. Cl. 367/20

(57) ABSTRACT

A seismic streamer includes a jacket covering an exterior of the streamer. At least one strength member extends along the length of the jacket. The strength member is disposed inside the jacket. Seismic sensors are disposed at spaced apart locations along the interior of the jacket. An acoustically transparent material fills the space inside the jacket. The material is introduced into the inside of the jacket in liquid form and undergoes a state change upon exposure to radiation. The radiation in one embodiment is ultraviolet radiation. The radiation in one embodiment is electron beam radiation.

### CROSS-REFERENCE TO RELATED APPLICATIONS

This application claims priority under 35 U.S.C. 119(e) to U.S. Provisional Application Ser. No. 60/716,279, filed on Sep. 12, 2005, entitled “Marine Seismic Streamer and Method for Manufacture Thereof”, the disclosure of which is incorporated herein by reference in its entirety.

### STATEMENT REGARDING FEDERALLY SPONSORED RESEARCH OR DEVELOPMENT

Not applicable.

### BACKGROUND OF THE INVENTION

1. Field of the Invention

The invention relates generally to the field of marine seismic data acquisition equipment. More specifically, the invention relates to structures for a marine seismic streamer, and methods for making such streamers.

2. Background Art

Marine seismic surveying is typically performed using “streamers” towed near the surface of a body of water by a seismic vessel. A streamer is in the most general sense a cable having a plurality of seismic sensors disposed thereon at spaced apart locations. The sensors are typically hydrophones, but can also be any type of sensor that is responsive to the pressure in the water, or in changes therein with respect to time. The sensors may also be any type of particle motion sensor or acceleration sensor known in the art. Irrespective of the type of sensors used in the streamer, the sensors generate an electrical or optical signal that is related to the parameter being measured. The electrical or optical signals are conducted along electrical conductors or optical fibers carried by the streamer to a recording system. The recording system is typically disposed on the seismic vessel, but may be disposed elsewhere.

In a typical marine seismic survey, a seismic energy source is actuated at selected times, and a record, with respect to time, of the signals detected by the one or more sensors is made in the recording system. The recorded signals are later used for interpretation to infer structure of, fluid content of, and composition of rock formations in the Earth's subsurface.

A typical marine seismic streamer can be up to several kilometers in length, and can include thousands of individual seismic sensors. Because of the weight of all of the materials used in a typical marine seismic streamer, because of the friction (drag) caused by the streamer as it is moved through the water, and because of the need to protect the sensors, electrical and/or optical conductors and associated equipment from water intrusion, a typical seismic streamer includes certain features. First, the streamer includes one or more strength members to transmit axial force along the length of the streamer. The strength member is operatively coupled to the seismic vessel and thus bears all the loading caused by the drag (friction) of the streamer in the water. The streamer also includes, as previously explained, electrical and/or optical conductors to carry electrical power and/or signals to the various sensors and (in certain streamers) signal conditioning equipment disposed in the streamer and to carry signals from the various sensors to a recording station. The streamer typically includes an exterior jacket that surrounds the other components in the streamer. The jacket is typically made from a strong, flexible plastic such as polyurethane, such that water is excluded from the interior thereof, and seismic energy can pass essentially unimpeded through the jacket to the sensors. A typical streamer also includes buoyancy devices at spaced apart locations therealong, so that the streamer so that the cable is substantially neutrally buoyant in the water. The interior of the jacket is typically filled with a hydrocarbon based oil, or blend of hydrocarbon based oils to provide buoyancy and to provide electrical insulation. Such oils are also substantially transparent to seismic energy.

A seismic streamer including the various components described above is typically made by inserting the various components inside the jacket, and filling the interior space within the jacket with oil or other electrically insulating material. It is known in the art to add materials to act as gelling agents for the hydrocarbon oils that are typically used as the filling material. The gelling process requires either a physical or chemical reaction between the gelling agent and the oil. The general approach to gelling the oil is to introduce a relatively low concentration of an appropriate, cross linked matrix polymer material into the oil. This is a well known principle for gel formation in hydrocarbons and is the basis for the formation of incendiary materials and weapons such as napalm and there are many formulations known in the art that effectively gel hydrocarbons. Such chemical gelling agents are typically either salts of organic acids or cross-linked polymers. The key to polymer-based gel formation is cross linking or network formation within the polymer. The addition of simple linear polymers in low concentration generally only increases the viscosity of hydrocarbon solutions, but cross linking of the polymers produces gels. The liquid prevents the polymer network from collapsing into a compact mass and the network in turn retains the liquid, thus forming gel. Some gels are cross-linked chemically by covalent bonds, other gels are cross-linked physically by weaker forces, such as hydrogen bonds and van der Waals forces. The present invention focuses on the use of covalent linkages because of their robust nature and the degree to which the materials involved can be modified by synthetic organic chemistry, thereby controlling and tuning their properties. Gelled materials can have a number of advantages over oil or other liquids when used as a material to fill the interior of a seismic streamer. An important one of these advantages is that such materials do not leak out of the jacket in the event the outer jacket becomes damaged. Similarly, such gels materials resist entry of water into the interior of the streamer in the event the jacket becomes damaged.

A disadvantage of using chemically reactive curing gelation materials known in the art for filling seismic streamers is the cure time. Curable materials known in the art for filling seismic streamers may take as long as two weeks to fully cure such that the streamers can be placed into service. During the cure time, the streamer is preferably stretched straight out and under tension in the manufacturing facility, in order to provide optimum geometric arrangement of the internal components of the streamer during cure. Thus, making a curable material-filled streamer using curable materials known in the art may require large manufacturing facilities having specialized equipment remaining essentially idle while curing takes place.

There is a need for a marine seismic streamer having a gellable fill material that can be manufactured more quickly than is possible using curable materials known in the art.

### SUMMARY OF THE INVENTION

One aspect of the invention is a seismic streamer, including a jacket covering an exterior of the streamer. At least one strength member extends along the length of the jacket. The strength member is disposed inside the jacket. Seismic sensors are disposed at spaced apart locations along the interior of the jacket. A flexible, acoustically transparent material fills the space inside the jacket. The material is introduced into the inside of the jacket in liquid form and undergoes a state change substantially to a gel upon exposure to radiation.

Another aspect of the invention is a method for making a seismic streamer. A method according to this aspect includes inserting at least one strength member and seismic sensors into a jacket. The jacket is then filled with a liquid having a composition adapted to undergo a change in state from liquid substantially to a gel after the filling, upon exposure to radiation

Other aspects and advantages of the invention will be apparent from the following description and the appended claims.

### BRIEF DESCRIPTION OF THE DRAWINGS

FIG. 1 shows typical marine seismic data acquisition using a streamer according to one embodiment of the invention.

FIG. 2 shows a cut away view of one embodiment of a streamer segment according to the invention.

FIGS. 3 and 4 show examples of cross-linking chemical reactions for a gelation agent according to the invention.

### DETAILED DESCRIPTION

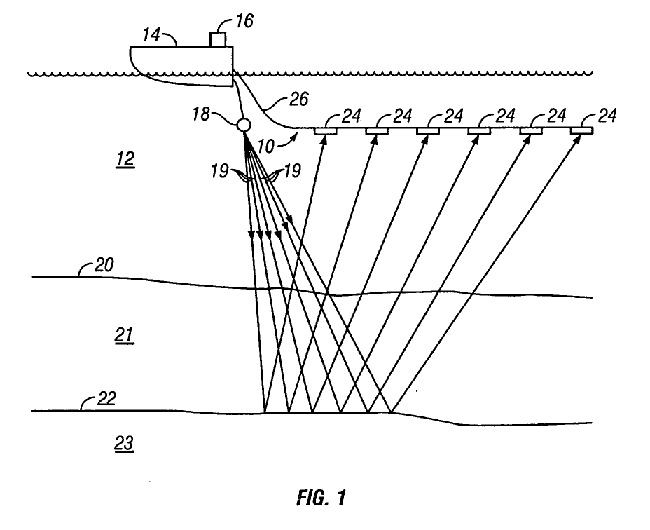

An example marine seismic data acquisition system as it is typically used in a marine seismic survey is shown in FIG. 1. A seismic vessel 14 moves along the surface of a body of water 12 such as a lake or the ocean. The marine seismic survey is intended to detect and record seismic signals related to structure and composition of various subsurface Earth formations 21, 23 below the water bottom 20. The seismic vessel 14 includes source actuation, data recording and navigation equipment, shown generally at 16, referred to for convenience as a “recording system.” The seismic vessel 14, or a different vessel (not shown), can tow one or more seismic energy sources 18, or arrays of such source(s) in the water 12. The system includes at least one seismic streamer 10, which includes a strength member 26 operatively coupled to the seismic vessel 14, and a plurality of sensors 24 or arrays of such sensors, disposed at spaced apart locations along the streamer 10. During operation, equipment (not shown separately) in the recording system 16 causes the source 18 to actuate at selected times. When actuated, the source 18 produces seismic energy 19 that emanates generally outwardly from the source 18. The energy 19 travels downwardly, through the water 12, and passes, at least in part, through the water bottom 20 into the formations 21, 23 below the water bottom 20. Seismic energy 19 can be reflected from one or more acoustic impedance boundaries 22 below the water bottom 20, and travels upwardly whereupon it may be detected by the sensors 24. Structure of the formations 21, 23 can be inferred by travel time of the energy 19 and by characteristics of the detected energy such as its amplitude and phase.

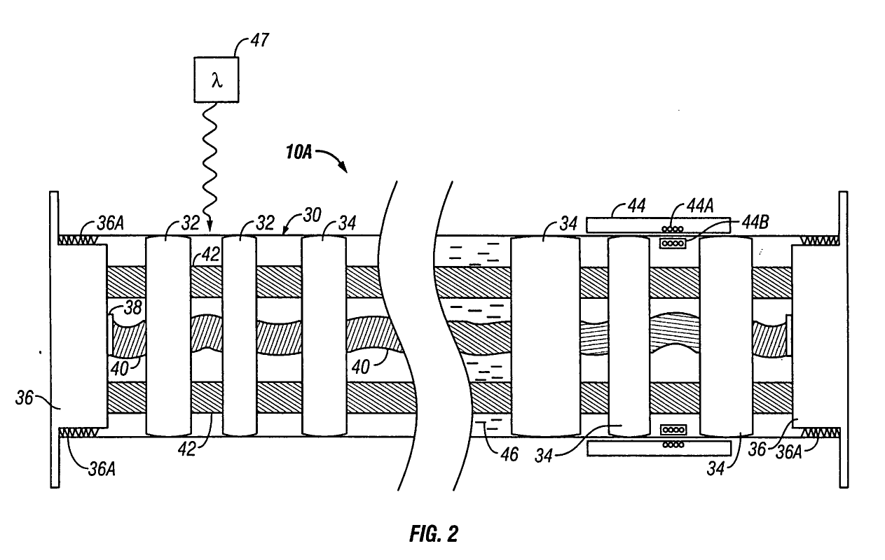

Having explained the general application for a marine seismic streamer, an example embodiment of a streamer according to the invention will be explained with reference to FIG. 2. FIG. 2 is a cut away view of a portion (segment) 10A of a marine seismic streamer (10 in FIG. 1). A streamer as shown in FIG. 1 may extend behind the seismic vessel (14 in FIG. 1) for several kilometers, and is typically made from a plurality of streamer segments, as shown in FIG. 2, connected end to end behind the seismic vessel (14 in FIG. 1).

The streamer segment 10A in the present embodiment may be about 75 meters overall length. The segment 10A includes a jacket 30, which in the present embodiment can be made from 3.5 mm thick transparent polyurethane, having a nominal external diameter of about 62 millimeters. In some embodiments, the jacket 30 may be externally banded in selected places with an alloy number 304 stainless steel, copper-flashed band (not shown).

In each segment 10A, each axial end of the jacket 30 may be terminated by a coupling/termination plate 36 (“termination plate”). The termination plate 36 may include elements 36A on the portion of its surface that is inserted into the end of the jacket 30 to seal against the inner surface of the jacket 30, and to grip the termination plate 36 to the jacket 30 when the jacket is clamped externally (not shown). In the present embodiment, two strength members 42 are coupled to an appropriate coupling feature (not shown separately) located on the interior of each termination plate 36. The strength members 42 extend the length of the segment 10A. In a particular implementation of the invention, the strength members 42 may be made from a fiber rope, using a fiber sold under the mark VECTRAN, which is a registered trademark of Hoechst Celanese Corp., New York, N.Y. The strength members 42 transmit axial force along the length of the segment 10A. When one segment 10A is coupled end to end to another segment (not shown in FIG. 2), mating termination plates 36 are coupled together using any suitable connector, so that the axial force is transmitted through the termination plates 36 from the strength members 42 in one segment 10A to the strength member in the adjoining segment.

The segment 10A typically includes spacers 32 and 34 disposed inside the jacket 30 at spaced apart locations along its length. The spacers may be of two types; buoyancy spacers 32 and structural or sensor spacers 34. The buoyancy spacers 32 may be made from foamed polypropylene. The buoyancy spacers 32 have a density selected to provide the segment 10A with approximately the same overall density as seawater (12 in FIG. 1), so that the streamer (10 in FIG. 1) will be substantially neutrally buoyant in seawater. As a practical matter, the buoyancy spacers 32 provide the segment 10A with an overall density very slightly less than that of fresh water. Appropriate overall density may then be adjusted in actual use by adding selected amounts of dense ballast (not shown) to the exterior of the jacket 30, thus providing adjustment in the buoyancy for changes in water temperature and salinity. The sensor spacers 34 may be made from foamed polyurethane or other suitable material. The sensor spacers 34 are used to support the jacket and provide a mounting platform for the sensors (not shown separately in the Figures).

The segment 10A can include a generally centrally located conductor harness 40 which typically includes a plurality of insulated electrical conductors (not shown separately), and may include one or more optical fibers (not shown separately). The electrical and/or optical conductors in the harness 40 conduct electrical and/or optical signals from the sensors (which will be further explained below) to the recording system (16 in FIG. 1). The harness 40 may also carry electrical power to various signal processing circuits (not shown separately) disposed in one or more segments 10A, or disposed elsewhere along the streamer (10 in FIG. 1). The length of the harness 40 within the streamer segment 10A is generally longer than the overall axial length of the segment 10A under the largest expected axial stress, so that the electrical conductors (and optical fibers if present) will not experience any substantial axial stress when the streamer (10 in FIG. 1) is towed through the water by the seismic vessel. The conductors and optical fibers may be terminated in a connector 38 disposed in each termination plate 36, so that when the segments 10A are connected end to end, corresponding electrical and/or optical connections may be made between the electrical conductors and optical fibers in the conductor harness in the adjoining segments 10A.

Sensors, which in the present embodiment may be hydrophones, velocity sensors, motion sensor, accelerometers or the like, can be disposed in selected ones of the sensor spacers, shown in FIG. 2 generally at 34. Hydrophones if used in the present embodiment can be or a type known to those of ordinary skill in the art, including but not limited to those sold under model number T-2BX by Teledyne Geophysical Instruments, Houston, Tex. In the present embodiment, each segment 10A may include 96 such hydrophones, disposed in arrays of sixteen individual hydrophones connected in electrical series. In a particular implementation of the invention, there are thus six such arrays, spaced apart from each other at about 12.5 meters. The spacing between individual hydrophones in each such array should be selected so that the axial span of the array is at most equal to about one half the wavelength of the highest frequency seismic energy intended to be detected by the streamer (10 in FIG. 1). It should be clearly understood that the types of sensors used, the electrical and/or optical connections used, the number of such sensors, and the spacing between such sensors are only used to illustrate one particular embodiment of the invention, and are not intended to limit the scope of this invention. In other embodiments, the sensors may be particle motion sensors such as geophones, or accelerometers. A marine seismic streamer having particle motion sensors is described in U.S. patent application Ser. No. 10/233,266, filed on Aug. 30, 2002, entitled, “Apparatus and Method for Multicomponent Marine Geophysical Data Gathering”, assigned to an affiliated company of the assignee of the present invention and incorporated herein by reference.

At selected positions along the streamer (10 in FIG. 1) a compass bird 44 may be affixed to the outer surface of the jacket 30. The compass bird 44 typically includes a directional sensor (not shown separately) for determining the geographic orientation of the segment 10A at the location of the compass bird 44. The compass bird 44 may include an electromagnetic signal transducer 44A for communicating signals to a corresponding transducer 44B inside the jacket 30 for communication along the conductor cable 40 to the recording system (16 in FIG. 1). Measurements of direction are used, as known in the art, to infer the position of the various sensors 34 in the segment 10A, and thus along the entire length of the streamer (10 in FIG. 1). Typically, a compass bird will be affixed to the streamer (10 in FIG. 1) about every 300 meters (every four segments 10A). One type of compass bird is described in U.S. Pat. No. 4,481,611 issued to Burrage and incorporated herein by reference.

In the present embodiment, the interior space of the jacket 30 may be filled with an acoustically transparent material 46 such as a blend of liquid hydrocarbon (oils) gelled by a radiation-curable cross-linked synthetic polymer. The gelled material 46, a mixture of the liquid hydrocarbon and the cross-linked polymer gelling agent, serves to exclude fluid (water) from the interior of the jacket 30, to electrically insulate the various components inside the jacket 30, and to transmit seismic energy freely through the jacket 30 to the sensors 34. The material 46 in its uncured state is essentially in liquid form. Upon gel formation, the material 46 no longer flows as a liquid, but instead becomes substantially gel-like. As a gel, the material 46 upon cure preferably retains some flexibility to bending stress and some elasticity, and freely transmits seismic energy to the sensors 34.

In the invention, the material 46 can be a hydrocarbon oil or oil blend that has been gelled using a radiation-curable gelation agent such as an elastomer polyurethane compound or other cross-linked elastomer. The foregoing elastomeric gelation agents are cured by exposure to ultraviolet radiation. As stated previously the addition of simple linear polymers in low concentration generally only increases the viscosity of hydrocarbon solutions but cross linking produces gels. The liquid prevents the polymer network from collapsing into a compact mass and the network in turn retains the liquid. Some gels are cross-linked chemically by covalent bonds, other gels are cross-linked physically by weaker forces, such as hydrogen bonds and van der Waals forces. The principle of the polymer based gelation is cross-linking or network formation. It is possible to form cross links by any of a number of chemical reactions between organic molecular groups that are pendent from polymer chains. The chemical linkages can be physical linkages such as those in soaps or nucleic acids, or they can be chemical reactions that form covalent bonds. The invention contemplates the use of covalent bonds because of their robust nature and the degree to which the materials used can be modified by synthetic organic chemistry, thereby controlling and tuning the gelation properties of the gelling agent. The foregoing ultraviolet radiation-cured materials would be essentially “instant” curing upon exposure to ultraviolet radiation. Such relatively rapid cure of the material 46 can substantially reduce the time required to manufacture such seismic streamers as compared with chemical curing, two-component polyurethane compounds known in the art for filling seismic streamers, which may take as long as two weeks to fully cure.

Other types of radiation-curable gelation agents that may be used in a streamer according to the invention include electron beam-curable elastomers. Such compounds are known generally by their chemical classification as acrylates and thiol-polyenes. See, for example, Technical Bulletin No. EPA/456-K-01-001, Ultraviolet and Electron Beam (UV/EB) Cured Coatings, Inks and Adhesives, Clean Air Technology Center, Office of Air Quality and Standards, United States Environmental Protection Agency, Research Park Triangle, N.C. (2001).

Additionally, it has been determined that suitable formulation s exist such that the radiation cross-linked polymer network can be selected to be thermally reversible. Examples of thermally reversible gelation compounds are described, for example, in U.S. Pat. No. 4,790,961 issued to Weiss et al., and U.S. Pat. No. 5,892,116 issued to Weiss et al. Additionally, the temperature at which the cross-linking can be broken can be selected by appropriate selection of such materials to be above the operating or storage temperature of the system. The reversible gelation feature of the foregoing gelling agents can be used in repairing a streamer section by heating the section to be repaired to the necessary temperature whereby the gel will-liquefy so as to enable separating from the harness (40 in FIG. 2), the strength members (42 in FIG. 2), and various spacers (32 and 34 in FIG. 2). After the liquefied gel is allowed to cool below the liquefaction temperature, the material will gel once again. Any gel lost in the liquefaction and repair procedure can be replaced with new, uncured gel that is subsequently cured by radiation exposure as explained above.

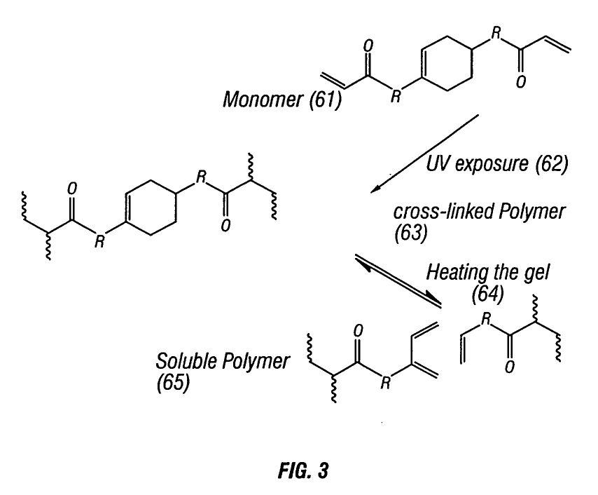

FIG. 3 shows an example of cross linkages created using so-called Diels Alder linkages. At 61, a monomer is shown by a structural chemical formula prior to exposure to radiation. At 62, the monomer is exposed to ultraviolet radiation such that a cross-linked polymer is formed, at 63. When suitably diffused into hydrocarbon oil, the cross-linked polymer 63 will cause gelling of the oil. When the gel is exposed to heat, at 64, so as to elevate its temperature above the cross-link stable temperature, the cross-linked polymer 63 changes to a soluble polymer, at 65, thus “breaking” (liquefying) the gel.

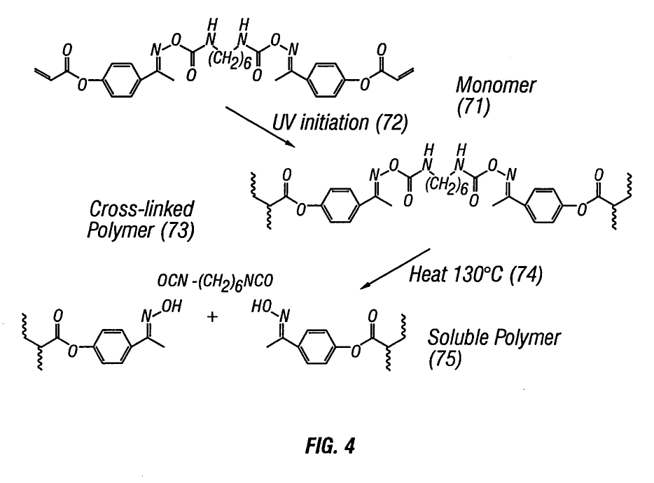

FIG. 4 shows an example of cross linkages created using oximinocarbamate linkages. At 71, a monomer is shown by a structural chemical formula prior to exposure to radiation. At 72, the monomer is exposed to ultraviolet radiation such that a cross-linked polymer is formed, at 73. When suitably diffused into hydrocarbon oil, the cross-linked polymer 73 will cause gelling of the oil. When the gel is exposed to heat, at 74, so as to elevate its temperature above the cross-link stable temperature, the cross-linked polymer 73 changes to a soluble polymer, at 75, thus “breaking” (liquefying) the gel.

In making a streamer according to the invention, first, the components described above including the sensor spacers 34 (some having at least one seismic sensor therein), buoyancy spacers 32, strength members 42 and conductor harness 40 are inserted into the jacket 30. The strength members 42 may then be stretched to approximately the same degree as would be the case when the streamer is in use towed by the seismic vessel (10 in FIG. 1). By applying the appropriate amount of axial tension to the strength members 42, the spacers 32 and the strength members 42 may be maintained in essentially the same geometry with respect to the jacket 30 that they will assume during operation of the streamer as towed by the seismic vessel. Then, the uncured material 46 is inserted into the interior of the jacket 30 to fill the space therein.

After inserting the material 46 into the interior of the jacket 30, the material 46 is exposed to a radiation source 47 of the type required to cure the material 46. The ultraviolet radiation curable polyurethane compounds described above would be exposed to ultraviolet radiation using well known apparatus. Electron beam curable materials may be processed in an electron beam curing apparatus, such as described in the Technical Bulletin referred to above.

When the material 46 is cured, the streamer segment 10A may be made ready for storage and transportation, such as on a reel (not shown). For the embodiment of the segment 10A shown in FIG. 2, during assembly, the termination plates 36 are coupled to the strength member 42, and inserted into the jacket 30. Tension may be applied to the strength members 42 during material cure by way of the termination plates 36, thus making a completed segment 10A. When made as described above, the streamer (10 in FIG. 1) will maintain essentially the same geometry of the various internal components, including the spacers 32, the sensors 34 and the strength members 42 irrespective of the amount the tension applied to the strength member 42.. If it should prove necessary to repair the streamer segment, the gel may be broken (returned to liquid state) by heating above the gel breaking temperature as explained above where appropriate gelation agents have been used.

Streamers and streamer segments made according to the various aspects of the invention may have reduced manufacturing time and cost associated therewith as compared with streamers made according to prior art methods using chemically cured materials.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A seismic streamer, comprising:
a jacket covering an exterior of the streamer;
at least one strength member extending along the length of the jacket, the strength member disposed inside the jacket;
seismic sensors disposed at spaced apart locations along the interior of the jacket; and
an acoustically transparent material filling space inside the jacket, the material having a composition such that it is introduced into the inside of the jacket substantially in liquid form and undergoes a state change thereafter to substantially solid upon exposure to radiation.

2. The streamer of claim 1 wherein the jacket comprises polyurethane.

3. The streamer of claim 1 wherein the material comprises ultraviolet radiation curable elastomeric gelation agent diffused into hydrocarbon oil.

4. The streamer of claim 3 wherein the material composition is selected such that gelation of the material is thermally reversible.

5. The streamer of claim 1 wherein the material comprises an electron beam curable elastomer gelation agent diffused into hydrocarbon oil.

6. The streamer of claim 5 wherein the material composition is selected such that gelation of the material is thermally reversible.

7. The streamer of claim 1 wherein the at least one strength member comprises fiber rope.

8. The streamer of claim 7 further comprising two or more strength members.

9. The streamer of claim 1 further comprising buoyancy spacers disposed long the strength member and inside the jacket at spaced apart locations, the spacers having a density selected to provide the streamer with a selected overall density.

10. The streamer of claim 9 wherein the spacers comprise foamed polypropylene.

11. The streamer of claim 1 further comprising a cable disposed inside the jacket, the cable having at least one of electrical conductors and optical fibers, the cable adapted to carry signals from the seismic sensors to a recording system.

12. The streamer of claim 1 wherein the device to be affixed externally to the jacket comprises a navigation device affixed to an exterior of the streamer at a selected location.

13. The streamer of claim 1 wherein the sensors comprise hydrophones.

14. The streamer of claim 1 wherein the sensors comprise at least one of velocity sensors and accelerometers.

15. The streamer of claim 1 further comprising a termination plate coupled to each axial end of the jacket, the termination plates each coupled to the strength member at an axial end thereof, the termination plates adapted to coupled to a corresponding termination plate in another segment of the streamer so as to transmit axial force therethrough.

16. A method for making a seismic streamer, comprising: inserting at least one strength member and seismic sensors into a jacket; filling the jacket with a material adapted to undergo a change in state from liquid to substantially solid after the filling upon exposure to radiation; and exposing the material to a source of the radiation.

17. The method of claim 14 further comprising placing the at least one strength member in a position with respect to the jacket that is the desired position of the strength member with respect to the jacket when the streamer is towed by a seismic vessel in a body of water, the placing performed at least at a location along the jacket to which a device is to be affixed externally, and holding the at least one strength member in the position during the state change in state.

18. The method of claim 17 wherein the location is used for a navigation device.

19. The method of claim 17 wherein the placing comprises applying tension to the at least one strength member.

20. The method of claim 16 wherein the exposing comprises exposing to ultraviolet radiation.

21. The method of claim 16 wherein the exposing comprises exposing to electron beam radiation.
